(19) United States
(12) Patent Application Publication
(10) Pub. No.: US 2026/0245002 A1
(43) Pub. Date: Aug. 20, 2026

(54) METHODS AND SYSTEMS FOR PROCESS MONITORING

(71) Applicant: ProptechCore AB, Strangnas (SE)

(72) Inventor: Patrik JOHANSSON, Strangnas (SE)

(21) Appl. No.: 18/858,919

(22) PCT Filed: May 17, 2022
(86) PCT No.: PCT/SE2022/050481

§ 371 Date: Oct. 22, 2024

(51) Int. Cl. G06Q 10/0631; G06N 20/00

(52) U.S. Cl. CPC G06Q 10/06311; G06N 20/00

(57) ABSTRACT

A method performed by a process monitoring system, for automatically monitoring process on site, whereby one or more devices, one or more persons and/or one or more materials being involved in performing the process. At least a subset of the one or more devices one or more persons and/or one or more materials are equipped with at least one position sensors separately. The method includes obtaining three-dimension (3D) position information during the process and generating one or more heat maps accordingly. The method further includes determining the start, delay and/or finish of one or more tasks based on the generated one or more heat maps by machine learning and notifying to a user.

### TECHNICAL FIELD

The present disclosure relates generally to methods and systems for process monitoring. The present disclosure also relates to computer programs and carriers corresponding to the above methods and systems.

### BACKGROUND

Nowadays, process management becomes more and more important. Process management is the discipline in which various methods are used to discover, model, analyze, measure, improve, optimize, and automate processes. In engineering, a process is a series of interrelated tasks that, together, transform inputs into a given output, e.g., construction, manufacturing, etc. These tasks may be carried out by people, nature or machines using various resources. Process includes one-time project, which is performed one time and finished. Process also includes repeated process, e.g., recurring producing process in factory. Process monitoring is one of the critical bases for process management. Process monitoring refers to monitor the progress of the process.

In prior art, process monitoring is performed manually, even when a digital tool, i.e., APP or website, is used. For example, one process includes one or more tasks or subtasks. When staff members are performing or have finished the tasks, each staff member reports the progress of his/her own task to the process manager. The process manager performs process management based on the reported task progress. For example, the process is building a house on a construction site. The staff members on the construction site, e.g., masons, plumbers, electricians, carpenters, painters report their working time and task progress respectively. For example, one painter reports that he has painted for six hours on one wall, and 50% of the wall surface is finished. The process manager on the construction site decides the process progress based on the reported situation, and make decision on the process progress, e.g., the process is going on time, or the process is delayed, or the process tasks needs to be optimized.

The manual process management method depends on the staff reported data and the decision of the process manager. The staff members may report inaccurate data or do not report in time. The process manager may make incorrect decision because of lacking experience or competence. Thus, this kind of manual process management may have low efficiency and wrong decision.

Therefore, there is a need to provide an effective, accurate and automated process management or process monitoring method and system.

### SUMMARY

It is an object of the invention to address at least some of the problems and issues outlined above. It is possible to achieve these objects and others by using methods, and systems as defined in the attached independent claims. It is an object of embodiments of the invention to monitor process in an efficient, accurate and automated way. It is an object of embodiments of the invention to provide accurate, complete and detailed data on process progress. It is an object of embodiments of the invention to train a machine learning model for process monitoring. It is possible to achieve one or more of these objects and possibly others by using methods and systems as defined in the attached independent claims.

According to one aspect, a method performed by a process monitoring system is provided. The method is used for automatically monitoring process on site. One or more device, person and/or material are involved in performing the process. At least a subset of the one or more device, person and/or material are equipped with at least one position sensor separately, the position sensor is able to wirelessly communicate with the process monitoring system. The method comprises obtaining three-dimension (3D) position information detected by the at least one position sensor wirelessly during the process. The method further comprises generating one or more heat map based on the obtained 3D position information and determine the start, delay and/or finish of one or more task based on the generated one or more heat map. The one or more tasks are performed by the subset of the one or more devices, persons and/or material, the one or more tasks are contained in the process, the demining is performed by machine learning. The method further comprises notifying the determined start, delay and/or finish of the one or more tasks to a user of the process monitoring system.

According to another aspect, a process monitoring system is provided. The process monitoring system is used for automatically monitoring process on site, whereby one or more devices, one or more persons and/or one or more materials being involved in performing the process. At least a subset of the one or more devices, one or more persons and/or one or more materials are equipped with at least one position sensors separately, the position sensors being able to wirelessly communicate with the process monitoring system. The process monitoring system is operative for obtaining three-dimension (3D) position information detected by the at least one position sensors wirelessly during the process. The system is further operative for generating one or more heat map based on the obtained 3D position information. The system is further operative for determining the start, delay and/or finish of one or more tasks based on the generated one or more heat maps, the one or more tasks being performed by involving the subset of the one or more devices, one or more persons and/or one or more materials, the one or more tasks being contained in the process, the determining being performed by machine learning. The system is further operative for notifying the determined start, delay and/or finish of the one or more tasks to a user of the process monitoring system.

According to other aspects, computer programs and carriers are also provided, the details of which will be described in the claims and the detailed description.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 is schematic block diagram of a working site.

FIG. 2 is schematic block diagram of process structure.

FIG. 3 is a flow chart illustrating a method performed by a process monitoring system, according to possible embodiments.

FIG. 4 is a heat map generated by the process monitoring system and displayed to the user, according to further possible embodiments.

FIG. 5 is a schematic block diagram for machine learning model input, output and training, according to possible embodiments.

FIG. 6 is a block diagram illustrating a process monitoring system in more detail, according to possible embodiments.

### DETAILED DESCRIPTION

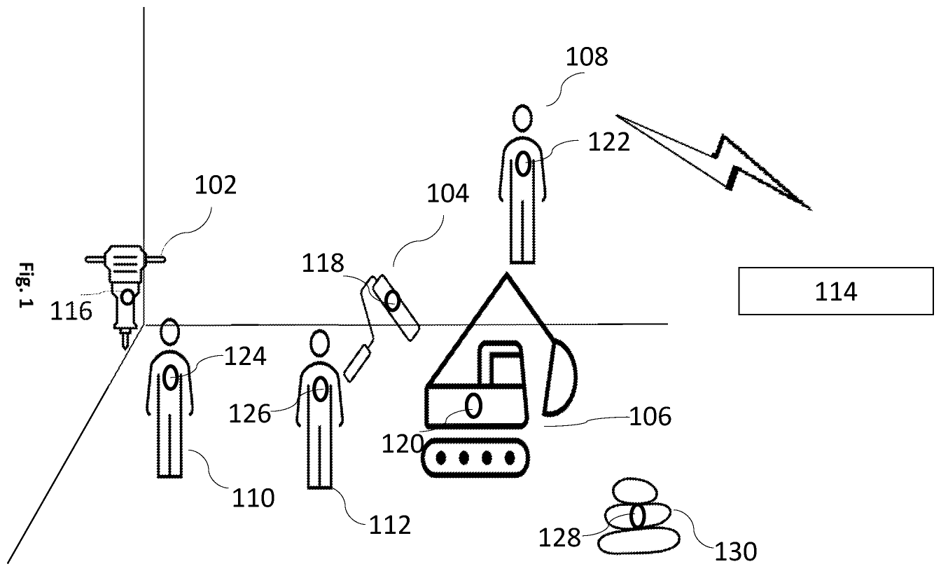

FIG. 1 shows a schematic diagram for a working site. The working site can be different kinds of working site, e.g., road construction site, real estate building site, renovation site, manufacturing plant, logistical management site, windmill farm maintenance, solar plant maintenance, etc. There are one or more devices, persons and/or materials involved in the working site and the one or more devices, persons and/or materials perform a process. As FIG. 1 shows, there are devices such as an excavator 106, a brush 104 and an electric drill 102 involved in the working site. Besides these devices shown in FIG. 1, the same can be applied to any device involved in activities on the working site, e.g., grinder, mixer, hammer, saw, cutter, forklift, ladder, movable waste disposal bin, spray paint device, cleaning device, truck, etc. There are also one or more persons involved in the working site, as shown in FIG. 1, persons 110, 112 and 108 are working on site. Besides devices and workers, one or more materials are also involved in the working site. As FIG. 1 shows, stones 130 are located on site. Besides stones, other kinds of materials can also be involved, e.g., cement, wood, brick, gypsum board, duct work, floor material, pallet goods, packages, etc. A process monitoring system 114 is deployed on the working site and can communicate with all the 3D position sensors wirelessly.

Each device, person and/or material is equipped with a 3D position sensor separately. As shown in FIG. 1, a 3D position sensor 116 is equipped on the electric drill 102. A 3D position sensor 124 is equipped on the person 110. A 3D position sensor 128 is equipped on the stones 130. Similarly, 3D position sensors 126, 118, 122, 120 are equipped on corresponding device/person/material 112, 104, 108, 106. The 3D position sensors are used to detect the 3D position of corresponding device/person/material and send the detected 3D position data wirelessly to a remote process monitoring system 114. The embodiments will be described in detail in following text.

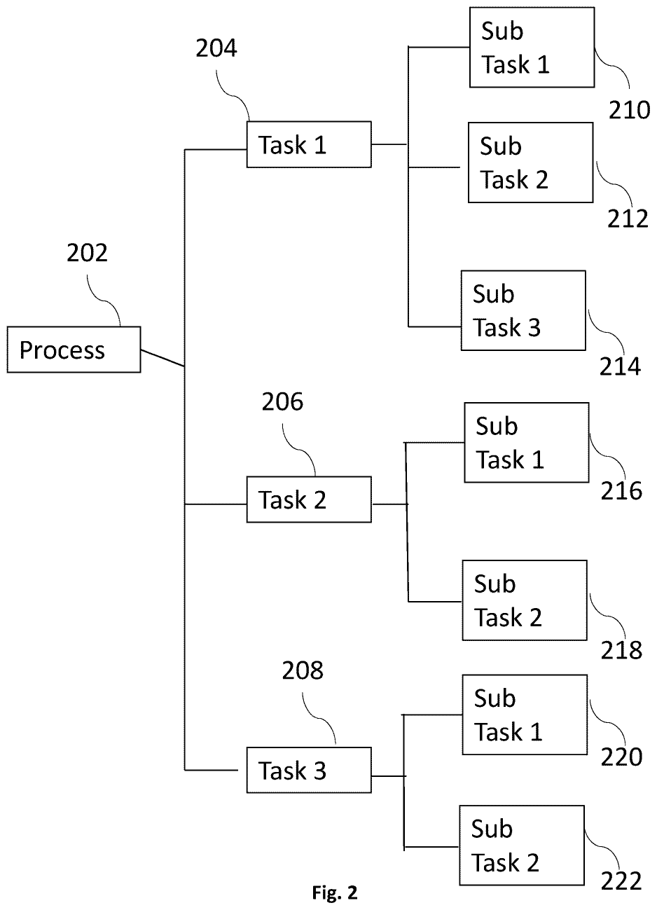

Referring to FIG. 2, a process 202 can be divided into tasks 204, 206 and 208. The process 202 can be the process discussed above and involve device, person and/or material. Each task can be further divided into subtasks, e.g., Task 1 204 can be divided into subtasks 210, 212, 214, Task 2 206 can be divided into subtasks 216, 218, Task 3 208 can be divided into subtasks 220, 222. Taking an example of the construction site shown in FIG. 1, if the process is to build a house, it can be divided into tasks e.g., building of foundation, building of main structure of the house, laying of water pipes and wires, interior decoration, etc. In another embodiment, the construction of each floor of the house can be one task. Each task can be divided into subtasks, for example, interior decoration can be divided into decoration of floor, decoration of wall, decoration of roof, etc. Each subtask can be further divided into smaller subtasks. Every task or subtask is performed by involving one or more device/person/material. For example, a subtask of painting one wall involves at least one person 112, at least one brush 104 and at least one bucket of paint (not shown in FIG. 1).

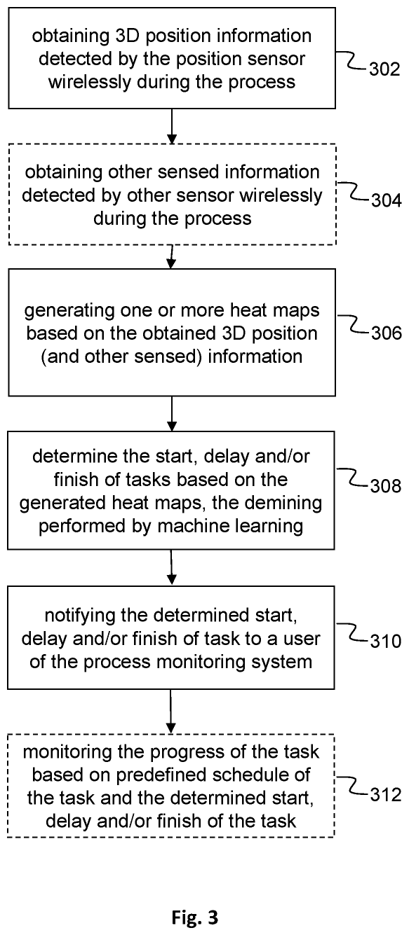

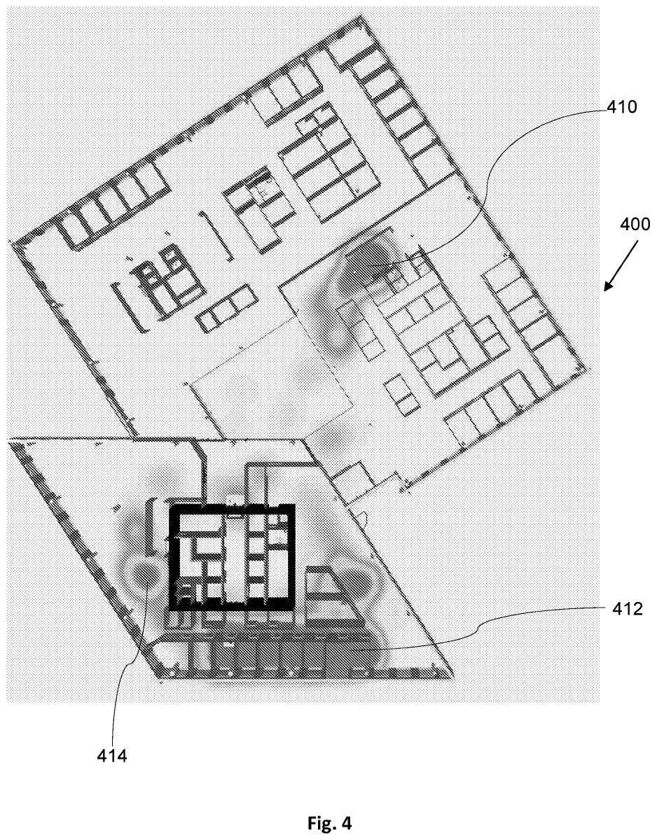

Referring to FIG. 3, in conjunction with FIGS. 1, 4, a method performed by a process monitoring system 114 for automatically monitoring process on site is provided. One or more devices 102, 104, 106, one or more persons 110, 112, 108 and/or one or more materials 130 are involved in performing the process. At least a subset of the one or more devices 102, 104, 106, one or more persons 110, 112, 108 and/or one or more materials 130 are equipped with at least one position sensors 116, 124, 126, 118, 120, 122, 128 separately. The position sensors 116, 124, 126, 118, 120, 122, 128 are able to wirelessly communicate with the process monitoring system 114. The method comprises obtaining 302 three-dimension (3D) position information detected by the at least one position sensors 116, 124, 126, 118, 120, 122, 128 wirelessly during the process. The method further comprises generating 306 one or more heat maps 400 based on the obtained 302 3D position information. The method further comprises determining 308 the start, delay and/or finish of one or more tasks based on the generated 306 one or more heat maps 400, the one or more tasks being performed by the subset of the one or more devices 102, 104, 106, one or more persons 110, 112, 108 and/or one or more materials 130, the one or more tasks being contained in the process and the determining 308 being performed by machine learning. The method further comprises notifying 310 the determined 308 start, delay and/or finish of the one or more task to a user of the process monitoring system 114.

The method is performed by the process monitoring system 114. The definition and examples of process have been explained in the background part. The position sensors 116, 124, 126, 118, 120, 122, 128 can wirelessly communicate with the process monitoring system 114 via different kinds of wireless communication protocol, e.g., 3G, LTE, 5G, Bluetooth, WiFi, Radio Frequency Identification (RFID), etc. The detected data can be sent from the position sensors 116, 124, 126, 118, 120, 122, 128 to the process monitoring system 114 wirelessly.

In the obtaining step 302, the 3D position of device/person/material can be detected by the position sensor equipped thereon. The process monitoring system 114 obtains the detected 3D position information wirelessly from the position sensors 116, 124, 126, 118, 120, 122, 128. The 3D position includes the position on x, y, z coordinate axis, and/or angle position. The obtaining of the 3D position information is in long term during the process, as long as the process is still being performed. Referring to FIG. 1, the 3D position of the person 112 can be detected by the position sensor 126 and sent to the process monitoring system 114 continuously during the process. The position sensor 126 detects the 3D position continuously at a predefined frequency, e.g., every one second. The process monitoring system 114 obtains the detected 3D position information continuously at a predefined frequency, e.g., also every one second. For example, the obtained 3D position information can be that the person 112 has been standing in front of a wall for five hours, including slight movements near it. The exact x/y/z coordinate values and their durations are detected by the sensor 116 and obtained by the process monitoring system 114. Similarly, the obtained 3D position information can be that the brush 104 has been moving within a certain range for five hours. The exact x/y/z coordinate values and their durations can be detected by the sensor 118 and obtained by the process monitoring system 114.

In the generating step 306, referring to FIG. 4, one or more heat maps 400 are generated based on the obtained 3D position information. The generated one or more heat maps can be heat map over time which indicates the 3D position information during a time period, e.g., one hour, one day, one task time period or one process time period, depending on the heat map settings. A heat map is a data visualization technique that shows magnitude of a phenomenon as color. The variation in color may be hue or intensity, giving obvious visual cues about how the phenomenon is clustered or varies over space. The generated heat maps can be 2D or 3D heat maps. Referring to FIG. 4, the background of the heat map 400 is the map of the working site. The colorful areas 410, 412, 414 are generated based on the obtained 3D position information during the time period. The different colors in the colorful areas 410, 412, 414 denotes the positions of one device/person/material which is equipped with the position sensor. For example, red shows that the device/person/material has been positioned in the red area for a longer period of time, yellow shows that the device/person/material has been positioned in the yellow area for a medium period of time and blue shows that the device/person/material has been positioned in the blue area for a shorter period of time. Therefore, the positions of the device/person/material are displayed by the heat map 400. The correspondence between colors and time periods depends on the heat map settings. In possible embodiments, heat maps show not only the positions of one device/person/material, but also the accuracy of the positions, e.g., 5 m, 10 m. Positions of each device/person/material generate one heat map. The colors shown in the FIG. 4 are schematic and some color information may be lost when the figure document is submitted. The skilled person in the art understands that the heat map 400 in FIG. 4 shows different colors in different areas. Different colors denote different information.

In the determining step 308, the start, delay and/or finish of each task are determined based on the generated heat maps. Referring to FIG. 2, the tasks are contained in the process and performed by involving the one or more devices 102, 104, 106, one or more persons 110, 112, 108 and/or one or more materials 130. Since the generated heat maps indicate all the 3D position information obtained from the position sensors 116, 124, 126, 118, 120, 122, 128, the start, delay and/or finish of the task can be determined based on some predetermined regulations. For example, if one heat map shows that one person/device begins to move from a stationary state, and keeps on moving for a predetermined long time, it is determined by the process monitoring system 114 that a task starts. In another example, another heat map indicates that one person/device has started the task, but the person/device has stopped for a long time later on. Considering the moving time is not enough for finishing the task, it is determined that the task is delayed. In further example, another heat map indicates that one material has been moving for an enough long period of time, it is determined that the task is finished. The 3D positions of devices, persons and materials shown in multiple heat maps can be integrated when determining the start, delay and/or finish of the task. In other words, the start, delay and/or finish of the task can be determined based on a combination of multiple heat maps, which indicate a combination of 3D positions of different devices/persons/materials involved in the task.

The determining step 308 can be performed by machine learning. Machine learning is the study of computer algorithms that can improve automatically through experience and using data. A machine learning model can be used when making the determination. The determining of the start/delay/finish of the task can be improved when more 3D position information is obtained and more heat maps are generated.

The notifying step 310 can be performed in various forms, e.g., notifying with text messages, reports, figures, sound, vibrations, flashing lights, etc. The user of the process monitoring system 114 can be the process manager.

By this method, tasks on a working site are monitored via 3D positions of the devices/persons/materials involved in the tasks. Such monitoring is totally automatic, high efficiency and accurate. Since the process comprises the tasks, the process is also monitored in a high efficiency, accurate and automatic way.

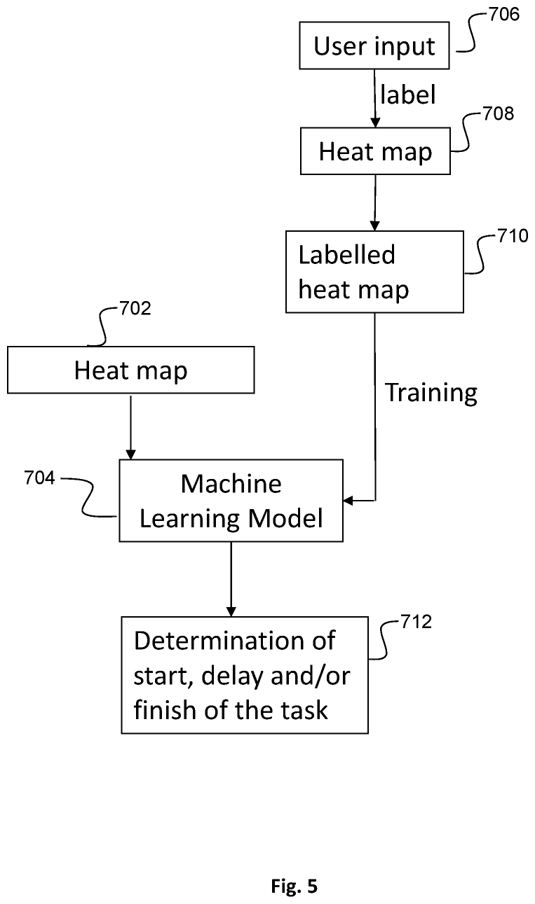

According to another embodiment, referring to FIG. 5, the method further comprises training the machine learning model based on user input.

As shown in FIG. 5, on one hand, a machine learning model 704 is used to perform determination of start, delay and/or finish of the task in 712 based on the inputted heat map 702. On the other hand, a user makes inputs 706 to a heat map 708. The heat map 708 is labelled based on the user input 706 and the heat map 708 becomes a labelled heat map 710. The labelled heat map 710 is used to train the machine learning model 704 so that the determination of start, delay and/or finish becomes more accurate.

According to another embodiment, the position sensor 116, 124, 126, 118, 120, 122, 128 comprises one or more of Global Positioning System (GPS) sensor, Bluetooth based positioning system sensor, Wireless Fidelity positioning system (WPS) sensor, narrow band 3D positioning system sensor, camera, Radar and height gauge. The camera and/or Radar may use Artificial Intelligence (AI) technology to identify an object and its position.

According to another embodiment, the method further comprises displaying the generated 306 one or more heat maps 400 to the user of the process monitoring system 114.

Referring to FIG. 4, by displaying the heat map directly to the user, on one hand the user, i.e., the process manager has a visual impression of how every device/person/material is positioned in a time period, and has a direct estimation of how one task is going on based on the colors of the heat maps. On the other hand, the user can label the heat maps 400, more easily and accurately when the heat maps 400 are displayed, so that the training of the machine learning model can be performed better, as explained above.

According to another embodiment, the subset of the one or more devices 102, 104, 106, persons 110, 112, 108 and/or one or more materials 130 is further equipped with at least one other sensor separately, the at least one other sensor being sensor type other than position sensor, such as one or more of gyroscope, accelerometer, vibration sensor, temperature sensor, sound sensor and light sensor, the at least one other sensor being able to wirelessly communicate with the process monitoring system 114. The method further comprises obtaining 304 other sensed information detected by the at least one other sensor wirelessly during the process. The generating 306 of one or more heat maps 400, further comprises generating the one or more heat maps 400 based on the obtained 304 other sensed information. For example, the generated heat map can show the intensity of a sound/vibration detected by a sound/vibration sensor equipped on one device/person/material during a time period.

By this embodiment, not only the 3D position information, but also other sensed information is obtained, e.g., angular velocity, acceleration, vibration, temperature, sound, light. The other sensed information also indicates working status on site. For example, the vibration of the electric drill 102 can be detected by a vibration sensor mounted thereon. When the vibration sensor detects that the electric drill 102 is vibrating, it means that the task is going on. If the vibration stops, the task is paused. Such obtained other sensed information is also used to generate the one or more heat maps, so that the determination of the start/delay/finish can be more accurate.

According to another embodiment, the method further comprises monitoring 312 the progress of the one or more tasks based on separate predefined schedule of each of the one or more tasks and the determined 308 start, delay and/or finish of the one or more tasks.

Each of the one or more tasks has its own predefined schedule, for example, the required start time the task, the required finish time of the task and the required duration of the task, the number of persons performing the task, etc. By comparing the determined start, delay and/or finish information and the predetermined task schedule, the progress of the task is monitored, and any deviation from the schedule can be discovered.

According to another embodiment, a process monitoring system 114 for automatically monitoring process on site is provided. One or more devices 102, 104, 106, one or more persons 110, 112, 108 and/or one or more materials 130 are involved in performing the process. At least a subset of the one or more devices 102, 104, 106, one or more persons 110, 112, 108 and/or one or more materials 130 are equipped with at least one position sensors 116, 124, 126, 118, 120, 122, 128 separately. The position sensors 116, 124, 126, 118, 120, 122, 128 are able to wirelessly communicate with the process monitoring system 114. The process monitoring system 114 is operative for obtaining three-dimension (3D) position information detected by the at least one position sensors 116, 124, 126, 118, 120, 122, 128 wirelessly during the process. The system 114 is further operative for generating one or more heat maps 400, based on the obtained 3D position information. The system 114 is further operative for determining the start, delay and/or finish of one or more tasks based on the generated one or more heat maps 400, the one or more tasks being performed by involving the subset of the one or more devices 102, 104, 106, one or more persons 110, 112, 108 and/or one or more materials 130, the one or more tasks being contained in the process, the determining being performed by machine learning. The system 114 is further operative for notifying the determined start, delay and/or finish of the one or more tasks to a user of the process monitoring system 114.

According to another embodiment, the process monitoring system 114 is further operative for training the machine learning model based on user input.

According to another embodiment, the position sensors 116, 124, 126, 118, 120, 122, 128 comprises one or more of Global Positioning System (GPS) sensor, Bluetooth based positioning system sensor, Wireless Fidelity positioning system (WPS) sensor, narrow band 3D position system sensor, camera, Radar and height gauge.

According to another embodiment, the process monitoring system 114 is further operative for displaying the generated one or more heat maps 400, to the user of the of the process monitoring system 114.

According to another embodiment, the subset of the one or more devices 102, 104, 106, one or more persons 110, 112, 108 and/or one or more materials 130 are further equipped with at least one other sensor separately, the at least one other sensor being sensor type other than position sensor, such as one or more of gyroscope, accelerometer, vibration sensor, temperature sensor, sound sensor, and light sensor, the at least one other sensor being able to wirelessly communicate with the process monitoring system 114, the process monitoring system 114 further being operative for obtaining other sensed information detected by the at least one other sensor wirelessly during the process; the generating of one or more heat maps 400 further comprises generating one or more heat maps 400 based on the obtained other sensed information.

According to another embodiment, the process monitoring system 114 is further operative for monitoring the progress of the one or more task based on separate predefined schedule of each of the one or more task and the determined start, delay and/or finish of the one or more task.

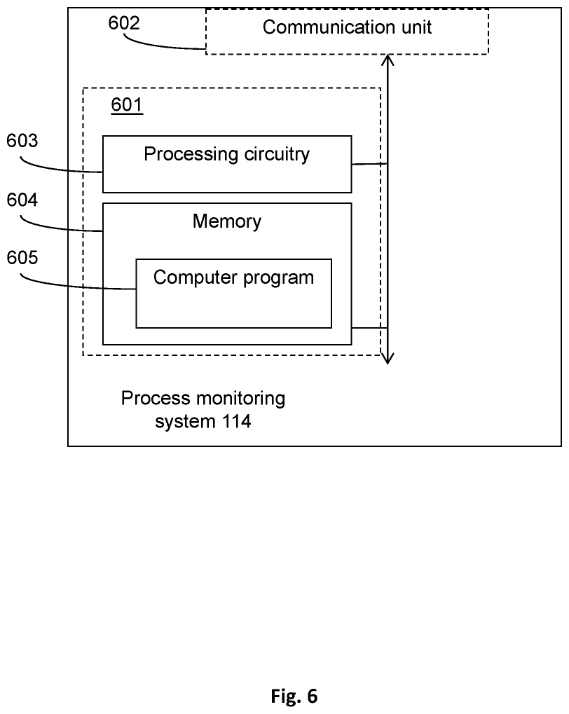

According to other embodiments, referring to FIG. 6, the process monitoring system 114 may further comprise a communication unit 602, which may be considered to comprise conventional means for wireless communication with the position/other sensors, such as a transceiver for wireless transmission and reception of signals. The instructions executable by said processing circuitry 603 may be arranged as a computer program 605 stored e.g. in said memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. The processing circuitry 603 may comprise one or more programmable processor, application-specific integrated circuits, field programmable gate arrays or combinations of these adapted to execute instructions.

The computer program 605 may be arranged such that when its instructions are run in the processing circuitry, they cause the process monitoring system 114 to perform the steps described in any of the described embodiments of the process monitoring system 114 and its method. The computer program 605 may be carried by a computer program product connectable to the processing circuitry 603. The computer program product may be the memory 604, or at least arranged in the memory. The memory 604 may be realized as for example a RAM (Random-access memory), ROM (Read-Only Memory) or an EEPROM (Electrical Erasable Programmable ROM). In some embodiments, a carrier may contain the computer program 605. The carrier may be one of an electronic signal, an optical signal, an electromagnetic signal, a magnetic signal, an electric signal, a radio signal, a microwave signal, or computer readable storage medium. The computer-readable storage medium may be e.g. a CD, DVD or flash memory, from which the program could be downloaded into the memory 604. Alternatively, the computer program may be stored on a server or any other entity to which the process monitoring system 114 has access via the communication unit 602. The computer program 605 may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” Further, the term “a number of”, such as in “a number of wireless devices” signifies one or more devices. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A method performed by a process monitoring system, for automatically monitoring process on site, whereby one or more devices, one or more persons and/or one or more materials being involved in performing the process, at least a subset of the one or more devices, one or more persons and/or one or more materials being equipped with at least one position sensors separately, the position sensors being able to wirelessly communicate with the process monitoring system the method comprising:
obtaining three-dimension (3D) position information detected by the at least one position sensors wirelessly during the process;
generating one or more heat maps based on the obtained 3D position information;
determining the start, delay and/or finish of one or more tasks based on the generated one or more heat maps, the one or more tasks being performed by involving the subset of the one or more devices, one or more persons and/or one or more materials, the one or more tasks being contained in the process, the determining being performed by machine learning;
notifying the determined start, delay and/or finish of the one or more tasks to a user of the process monitoring system.

2. The method as claimed in claim 1, the method further comprises:
training the machine learning model based on user input.

3. The method as claimed in claim 1, the position sensors comprises one or more of Global Positioning System (GPS) sensor, Bluetooth based positioning system sensor, Wireless Fidelity positioning system (WPS) sensor, narrow band 3D positioning system sensor, camera, Radar and height gauge.

4. The method as claimed in claim 1, the method further comprises:
displaying the generated one or more heat maps to the user of the of the process monitoring system.

5. The method as claimed in claim 1, the subset of the one or more devices, one or more persons and/or one or more materials being further equipped with at least one other sensor separately, the at least one other sensor being sensor type other than position sensor, the at least one other sensor being able to wirelessly communicate with the process monitoring system, the method further comprises:
obtaining other sensed information detected by the at least one other sensor wirelessly during the process;
the generating of one or more heat maps further comprises:
generating the one or more heat maps based on the obtained other sensed information.

6. The method as claimed in claim 1, the methods further comprises:
monitoring the progress of the one or more tasks based on separate predefined schedule of each of the one or more tasks and the determined start, delay and/or finish of the one or more task.

7. A process monitoring system for automatically monitoring process on site, whereby one or more devices, one or more persons and/or one or more materials being involved in performing the process, at least a subset of the one or more devices, one or more persons and/or one or more materials being equipped with at least one position sensors separately, the position sensors being able to wirelessly communicate with the process monitoring system, whereby the process monitoring system is operative for:
obtaining three-dimension (3D) position information detected by the at least one position sensors wirelessly during the process;
generating one or more heat maps based on the obtained 3D position information;
determining the start, delay and/or finish of one or more tasks based on the generated one or more heat maps, the one or more tasks being performed by involving the subset of the one or more devices, one or more persons and/or one or more materials, the one or more tasks being contained in the process, the determining being performed by machine learning;
notifying the determined start, delay and/or finish of the one or more tasks to a user of the process monitoring system.

8. The process monitoring system as claimed in claim 7, wherein the process monitoring system is further operative for training the machine learning model based on user input.

9. The process monitoring system as claimed in claim 7, the position sensors comprises one or more of Global Positioning System (GPS) sensor, Bluetooth based positioning system sensor, Wireless Fidelity positioning system (WPS) sensor, narrow band 3D positioning system sensor, camera, Radar and height gauge.

10. The process monitoring system as claimed in claim 7, the process monitoring system is further operative for displaying the generated one or more heat maps to the user of the of the process monitoring system.

11. The process monitoring system as claimed in claim 7, the subset of the one or more devices, one or more persons and/or one or more materials being further equipped with at least one other sensor separately, the at least one other sensor being sensor type other than position sensor, the at least one other sensor being able to wirelessly communicate with the process monitoring system, the process monitoring system further being operative for:
obtaining other sensed information detected by the at least one other sensor wirelessly the process;
the generating of one or more heat maps further comprises:
generating the one or more heat maps based on the obtained other sensed information.

12. The process monitoring system as claimed in claim 7, the process monitoring system is further operative for:
monitoring the progress of the one or more task based on separate predefined schedule of each of the one or more task and the determined start, delay and/or finish of the one or more task.

13. A computer program comprising instructions, which, when executed by a processing circuitry of a process monitoring system, configured for automatically monitoring process on site, whereby one or more devices, one or more persons and/or one or more materials being involved in performing the process, at least a subset of the one or more devices, one or more persons and/or one or more materials being equipped with at least one position sensors separately, the position sensors being able to wirelessly communicate with the process monitoring system, the computer program causes the process monitoring system to perform the following steps:
obtaining three-dimension (3D) position information detected by the at least one position sensors wirelessly during the process;
generating one or more heat maps based on the obtained 3D position information;
determining the start, delay and/or finish of one or more tasks based on the generated one or more heat maps, the one or more tasks being performed by involving the subset of the one or more devices, one or more persons and/or one or more materials, the one or more tasks being contained in the process, the determining being performed by machine learning;
notifying the determined start, delay and/or finish of the one or more tasks to a user of the process monitoring system.

14. (canceled)

15. The method as claimed in claim 5, wherein the at least one other sensor is one or more of a gyroscope, accelerometer, vibration sensor, temperature sensor, sound sensor and light sensor.

16. The process monitoring system as claimed in claim 11, wherein the at least one other sensor is one or more of a gyroscope, accelerometer, vibration sensor, temperature sensor, sound sensor and light sensor.
